(19) United States
(12) Patent Application Publication
(10) Pub. No.: US 2025/0368140 A1
(43) Pub. Date: Dec. 4, 2025

(54) LID STRUCTURE FOR VEHICLE MOUNTED CONTAINER

(71) Applicant: NIFCO INC., Yokosuka-shi (JP)

(72) Inventors: Atsushi DOI, Yokosuka-shi (JP); Fumika NISHIJI, Yokohama-shi (JP); Yayoi NAKAGORI, Yokohama-shi (JP)

(21) Appl. No.: 19/173,817

(22) Filed: Apr. 9, 2025

(30) Foreign Application Priority Data
May 28, 2024 (JP) 2024-086344

(51) Int. Cl. B60R 7/04; B65D 43/20

(52) U.S. Cl. CPC B60R 7/04; B65D 43/20

(57) ABSTRACT

A lid structure for a vehicle mounted container includes a main body including an opening portion communicating with an inner storage space, the opening portion being on a top face of the main body; and a lid configured to open or close the opening portion. Lid rail portions formed on two sides of the lid are fit in a slidable manner to sidewall rail portions formed on respective inner faces in a pair of sidewall portions as side faces of the main body, so that the lid slides along the opening portion. The lid has through holes communicating with the storage space.

### CROSS-REFERENCE TO RELATED APPLICATION

The present application claims priority of Japanese Patent Application No. 2024-086344 filed on May 28, 2024, the disclosure of which is incorporated herein in its entirety.

### FIELD OF THE INVENTION

The present disclosure relates to a lid structure for a vehicle mounted container to be mounted on an automobile.

### BACKGROUND OF THE INVENTION

Conventionally, in a type of an automobile, there is a console box for small articles, such as storable articles, in its center console. For example, a console box described in Patent Literature 1 (hereinafter, referred to as the “invention in publicly known literature 1”) includes a box type case having an opening portion and a shutter that slides to open or close the opening portion. In detail, the opening portion has an edge provided with a guide groove, whereas the shutter has an edge provided with protrusions fitted slidably to the guide groove.

### Prior Art Literature

Patent Literature 1: WO 2017/043579

### SUMMARY OF THE INVENTION

### Problems to be Solved by the Invention

However, according to the invention, in publicly known literature 1, in a case where sand, dust, liquid, or the like on the top face of the shutter (hereinafter, referred to as “foreign matter”) enters between a guide groove and protrusions, the shutter fails to slide smoothly, leading to a deterioration in operability.

The present invention has been made in consideration of such a situation, and an object of the present invention is to provide a lid structure for a vehicle mounted container that is capable of preventing entry of foreign matter and maintaining high operability. In a broader sense, the present invention is directed to maintenance of a comfortable environment, which is a universal issue, with maintenance of convenience.

### Means to solve the Invention

In order to achieve the above-described objects, according to the present invention, a lid structure for a vehicle mounted container comprises a main body including an opening portion in communication with an inner storage space, the opening portion being on a top face of the main body; and a lid configured to open or close the opening portion, in which lid rail portions formed on both sides of the lid are fit in a slidable manner to sidewall rail portions formed on respective inner faces in a pair of sidewall portions as side faces of the main body, allowing the lid to slide along the opening portion, and the lid has a through hole communicating with the storage space.

According to the present invention, in the lid structure for the vehicle mounted container, the lid includes a plurality of hinge portions extending across and between the end portions, and is capable of bending through the hinge portions when sliding.

According to the present invention, in the lid structure for the vehicle mounted container, the through hole is formed in the hinge portions.

According to the present invention, in the lid structure for the vehicle mounted container, in each of the end portions, in a direction toward a fitting area between the lid rail portion and the sidewall rail portion corresponding thereto, the through hole is formed at a position before the fitting area.

According to the present invention, in the lid structure for the vehicle mounted container, the lid rail portions protrude to the sidewall rail portion corresponding thereto, and the lid rail portions included in each of the lid rail portions each include a slope portion at a position on a top face of the lid rail portion before a fitting area between the lid rail portion and the corresponding sidewall rail portion, the slope portion sloping to a gap formed between the lid rail portions adjacent to one another.

According to the present invention, in the lid structure for the vehicle mounted container, the main body includes a regulatory member that restricts the lid from opening due to acceleration.

According to the present invention, in the lid structure for the vehicle mounted container, the lid includes a cover portion that covers the regulatory member.

According to the present invention, in the lid structure for the vehicle mounted container, the lid includes a rib that protrudes upward and has a longitudinal direction identical to a direction in which the lid rail portions extend.

According to the present invention, in the lid structure for the vehicle mounted container, in each of the end portions, in a direction toward a fitting area between the lid rail portion and the corresponding sidewall rail portion, the rib is formed on a side before the fitting area.

According to the present invention, in the lid structure for the vehicle mounted container, in each of the end portions, in a direction toward a fitting area between the lid rail portion and the corresponding sidewall rail portion, the rib is located on a side beyond the through hole.

According to the present invention, in the lid structure for the vehicle mounted container, the lid includes a plurality of lid pieces connected through the hinge portions, and a plurality of the ribs formed on respective adjacent lid pieces extends in directions in which the ribs come close to each other, the ribs overlapping each other with a gap.

According to the present invention, the lid structure for the vehicle mounted container comprises a main body including an opening portion in communication with an inner storage space, the opening portion being on a top face of the main body; and a lid configured to open or close the opening portion, in which lid rail portions formed on both sides of the lid are fit in a slidable manner to sidewall rail portions formed on respective inner faces in a pair of sidewall portions as side faces of the main body, allowing the lid to slide along the opening portion, and the lid has a through hole in communication with the storage space. Foreign matter on the lid falls through the through hole, and thus the foreign matter fails to enter a fitting area between each lid rail portion and the corresponding sidewall rail portion (hereinafter, simply referred to as a “fitting area”). Therefore, the lid structure for the vehicle mounted container is capable of preventing entry of foreign matter and maintaining high operability.

According to the present invention, in the lid structure for the vehicle mounted container, the lid includes a plurality of hinge portions extending across and between the end portions, and is capable of bending through the hinge portions when sliding. That is, the lid bends through the hinge portions. Therefore, the lid structure for the vehicle mounted container enables the lid rail portions and the sidewall rail portions to be stored in a small space.

According to the present invention, in the lid structure for the vehicle mounted container, the through hole is formed in the hinge portions. Foreign matter in any of the hinge portions falls through the through hole and thus fails to enter the fitting area. Therefore, the lid structure for the vehicle mounted container is capable of preventing entry of foreign matter and maintaining high operability.

According to the present invention, in the lid structure for the vehicle mounted container, in each of the end portions, in a direction toward a fitting area between the lid rail portion and the corresponding sidewall rail portion, the through hole is formed at a position before the fitting area. Even in a case where foreign matter on the lid moves toward either end portion, the foreign matter falls through the through hole without reaching the fitting area, so that the foreign matter fails to enter the fitting area. Therefore, the lid structure for the vehicle mounted container is capable of preventing entry of foreign matter and maintaining high operability. In general, in a case where the lid structure for the vehicle mounted container is installed in a vehicle, the end portions are covered with an interior panel for design, and thus the through hole is also shielded by the interior panel. Therefore, the external appearance is not spoiled by the through hole.

According to the present invention, in the lid structure for the vehicle mounted container, the lid rail portions protrude to the corresponding sidewall rail portion, and the lid rail portions included in each of the lid rail portions each include a slope portion at a position on a top face of the lid rail portion before a fitting area between the lid rail portion and the corresponding sidewall rail portion, the slope portion sloping to a gap formed between the lid rail portions adjacent to one another. Even in a case where foreign matter on the lid moves toward either end portion, the foreign matter slides along any of the slope portions without reaching the fitting area and then falls through the gap, so that the foreign matter fails to enter the fitting area. Therefore, the lid structure for the vehicle mounted container is capable of preventing entry of foreign matter and maintaining high operability.

According to the present invention, in the lid structure for the vehicle mounted container, the main body includes a regulatory member that restricts the lid from opening due to acceleration. If the vehicle gains a large acceleration, the lid tries to open due to inertial force, but the regulatory member operates to restrict the lid from opening. Therefore, the lid does not open unintentionally.

According to the present invention, in the lid structure for the vehicle mounted container, the lid includes a cover portion that covers the regulatory member. Therefore, foreign matter fails to enter the regulatory member.

According to the present invention, in the lid structure for the vehicle mounted container, the lid includes a rib that protrudes upward and has a longitudinal direction identical to a direction in which the lid rail portions extend. Foreign matter on the lid is blocked after butting against the rib, so that the foreign matter fails to enter the fitting area. Therefore, the lid structure for the vehicle mounted container enables prevention of entry of foreign matter to the regulatory member.

According to the present invention, in the lid structure for the vehicle mounted container, in each of the end portions, in a direction toward a fitting area between the lid rail portion and the corresponding sidewall rail portion, the rib is formed at a position not reaching the fitting area. Even in a case where foreign matter on the lid moves toward either end portion, the foreign matter is blocked after butting against the rib without reaching the fitting area, so that the foreign matter fails to enter the fitting area. Therefore, the lid structure for the vehicle mounted container is capable of preventing entry of foreign matter and maintaining high operability. In general, in a case where the lid structure for the vehicle mounted container is installed in a vehicle, the end portions are covered with an interior panel for design, and thus the rib is also shielded by the interior panel. Therefore, the external appearance is not spoiled by the rib.

According to the present invention, in the lid structure for the vehicle mounted container, in each of the end portions, in a direction toward a fitting area between the lid rail portion and the corresponding sidewall rail portion, the rib is located at a position beyond the through hole. Even in a case where foreign matter on the lid moves toward either end portion, the foreign matter is blocked after butting against the rib and then falls through the through hole, so that the foreign matter fails to enter the fitting area. Therefore, the lid structure for the vehicle mounted container is capable of preventing entry of foreign matter and maintaining high operability.

According to the present invention, in the lid structure for the vehicle mounted container, the lid includes a plurality of lid pieces connected through the hinge portions, and a plurality of the ribs formed on respective adjacent lid pieces extends in directions in which the ribs come close to each other, the ribs overlapping each other with a gap. Even in a case where foreign matter on the lid moves toward either end portion, the foreign matter is blocked after butting against the overlapping ribs, so that the foreign matter fails to enter the fitting area. Therefore, the lid structure for the vehicle mounted container is capable of preventing entry of foreign matter and maintaining high operability.

### BRIEF DESCRIPTION OF THE DRAWINGS

FIG. 1 is a perspective view of a lid structure for a vehicle mounted container according to a first embodiment of the present disclosure.

FIG. 2 is a top view of the lid structure for the vehicle mounted container according to the first embodiment of the present disclosure.

FIG. 3 is a front view of the lid structure for the vehicle mounted container according to the first embodiment of the present disclosure.

FIG. 4 is an exploded perspective view of the lid structure for the vehicle mounted container according to the first embodiment of the present disclosure.

FIG. 5 includes a perspective view and an enlarged end view of a lid in the lid structure for the vehicle mounted container according to the first embodiment of the present disclosure.

FIG. 6 includes a top view and an enlarged end view of the lid in the lid structure for the vehicle mounted container according to the first embodiment of the present disclosure.

FIG. 7 includes a front view and an enlarged end view of the lid in the lid structure for the vehicle mounted container according to the first embodiment of the present disclosure.

FIG. 8 includes a side view and an enlarged end view of the lid in the lid structure for the vehicle mounted container according to the first embodiment of the present disclosure.

FIG. 9 is a first enlarged sectional view of an end portion in the lid structure for the vehicle mounted container according to the first embodiment of the present disclosure, corresponding to an enlarged partial view taken along line IX-IX of FIG. 2.

FIG. 10 is a second enlarged sectional view of the end portion in the lid structure for the vehicle mounted container according to the first embodiment of the present disclosure, corresponding to an enlarged partial view taken along line X-X of FIG. 2.

FIG. 11 is an enlarged end view of a lid structure for the vehicle mounted container according to a second embodiment of the present disclosure.

### DETAILED DESCRIPTION OF EMBODIMENTS

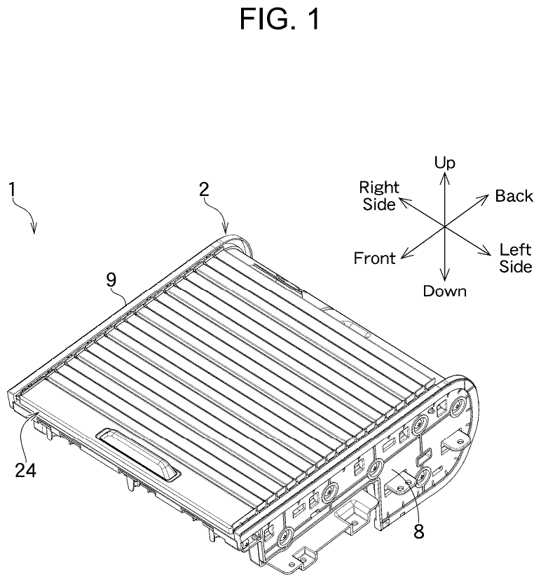

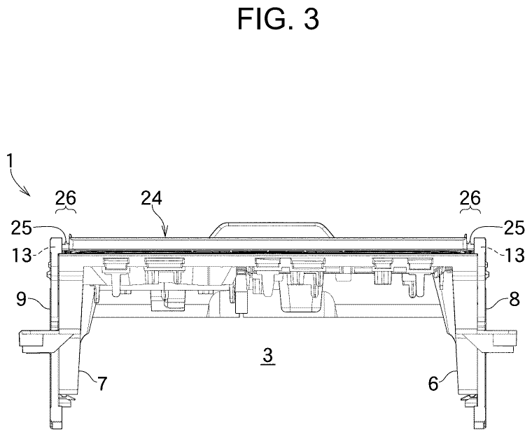

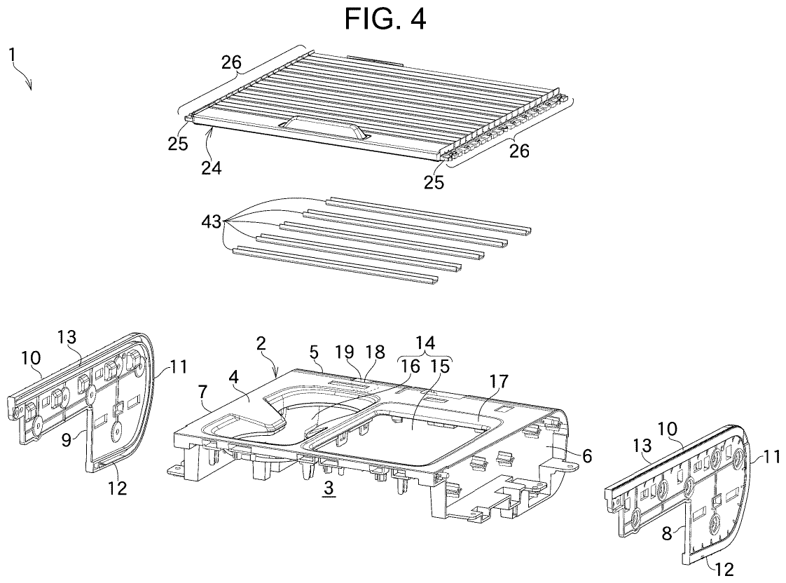

Lid structures for a vehicle mounted container according to embodiments of the present disclosure will be described below based on the drawings. FIGS. 1 to 3 illustrate the external appearance of a lid structure 1 for a vehicle mounted container according to a first embodiment of the present disclosure. FIG. 4 illustrates the exploded lid structure 1 for a vehicle mounted container. As illustrated in FIGS. 1 to 4, the lid structure 1 for the vehicle mounted container allows a lid 24 to slide with respect to a main body 2 having a storage space 3 inside to open or close an opening portion 14, on the top face of the main body 2, in communication with the storage space 3. For example, the lid structure 1 for the vehicle mounted container is designed to be installed in a center console in an automobile (not illustrated). Note that, in the following, the direction in which the lid 24 opens is defined as back (Back), the direction in which the lid 24 closes is defined as front (Front), the breadth direction of the lid 24 is defined as right (Right Side) or left (Left Side), and the depth direction of the main body 2 is defined as up (Up) or down (Down) (refer to FIG. 1).

As illustrated in FIGS. 1 to 4, the lid structure 1 for the vehicle mounted container includes the main body 2 and the lid 24. The main body 2 includes a top portion 4 having the opening portion 14, a rear portion 5 connected to the rear of the top portion 4, a left inner side portion 6 connected to a side of the top portion 4 and a side of the rear portion 5, a right inner side portion 7 connected to the other side of the top portion 4 and the other side of the rear portion 5, and a pair of sidewall portions attached to the left inner side portion 6 and the right inner side portion 7, respectively. The pair of sidewall portions includes a left sidewall portion 8 attached to the left inner side portion 6 and a right sidewall portion 9 attached to the right inner side portion 7.

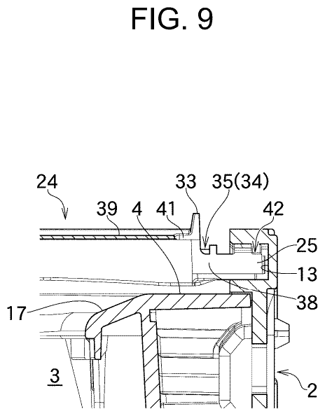

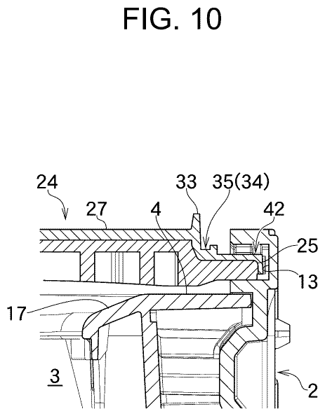

The top portion 4 is almost quadrilateral and approximates to a square (in other words, the top portion 4 is not rectangular). The opening portion 14 of the top portion 4 includes, as sections, a right opening portion 15 and a left opening portion 16. The right opening portion 15 is almost quadrilateral and the left opening portion 16 is shaped like two circles, in front and behind, coupled together. The opening portion 14 has, as an edge, an opening edge 17 that slopes down toward the storage space 3 (refer to FIGS. 9 and 10). The rear portion 5 gently curves as extending backward from the top portion 4. The top portion 4 has a connection area to the rear portion 5, and the connection area is provided with a regulatory member housing portion 18. The regulatory member housing portion 18 corresponds to a downward recess. A regulatory member 19, which restricts the lid 24 from opening due to acceleration, is housed in and attached to the regulatory member housing portion 18. The regulatory member 19 functions as a so-called acceleration sensor.

The regulatory member 19 includes a rod-like pivot shaft portion that extends left and right. The pivot shaft portion is supported inside the regulatory member housing portion 18 and thus the regulatory member 19 swings around the pivot shaft portion. The regulatory member 19 swings to change between a regulatory posture in which its front end portion protrudes from the main body 2 and a non-regulatory posture in which the front end portion is housed in the regulatory member housing portion 18 without protruding from the main body 2. In a case where no excessive external force is applied to the regulatory member 19, the regulatory member 19 maintains the non-regulatory posture. On the other hand, for example, in a case where acceleration is generated due to an excessive external force, such as a sudden start, a sudden stop, or a collision, the regulatory member 19 changes to the regulatory posture.

The left and right sidewall portions 8 and 9 are each flat in shape and each have an upward facing edge portion that extends straight backward and forward and additionally curves along the shape of the rear portion 5, extending forward while turning. That is, each edge portion includes an upper straight edge portion 10, a curved edge portion 11 connected to the rear of the upper straight edge portion 10, and a lower straight edge portion 12 connected to the curved edge portion 11. The edge portions 10, 11, and 12 each have an inner face provided with a grooved sidewall rail portion 13.

The lid 24 is almost quadrilateral and is plate-like when viewed from above. In addition, the lid 24 has a so-called accordion structure and thus bends freely when sliding. The lid 24 has end portions 26 in its left-right direction orthogonal to the front-back direction in which the lid 24 slides, and the end portions 26 are each provided with lid rail portions 25. The lid rail portions 25 each protrude in the left-right direction from the corresponding end portion 26 to the corresponding sidewall rail portion 13 of the main body 2 and extend in the front-back direction. The lid rail portions 25 are each fitted slidably to the corresponding sidewall rail portion 13, and thus the lid 24 slides along the opening portion 14. The lid 24 has a bottom face to which a plurality of brackets 43 is attached. The brackets 43 are made of metal and have their longitudinal directions identical to the left-right direction.

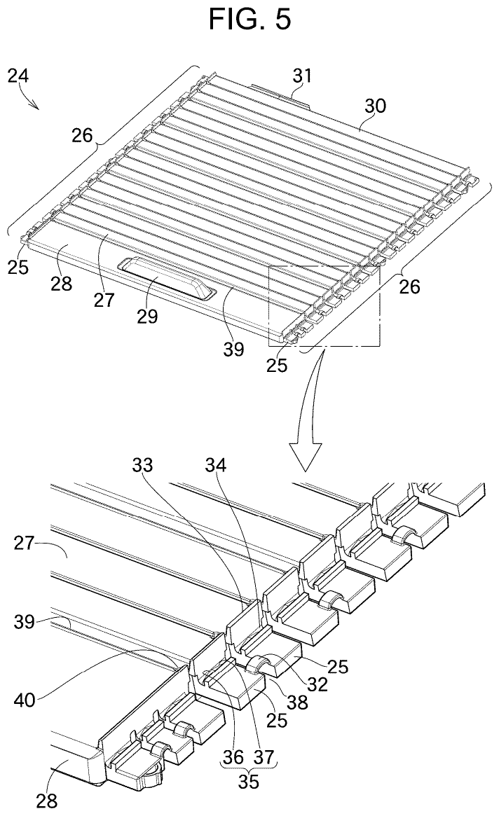

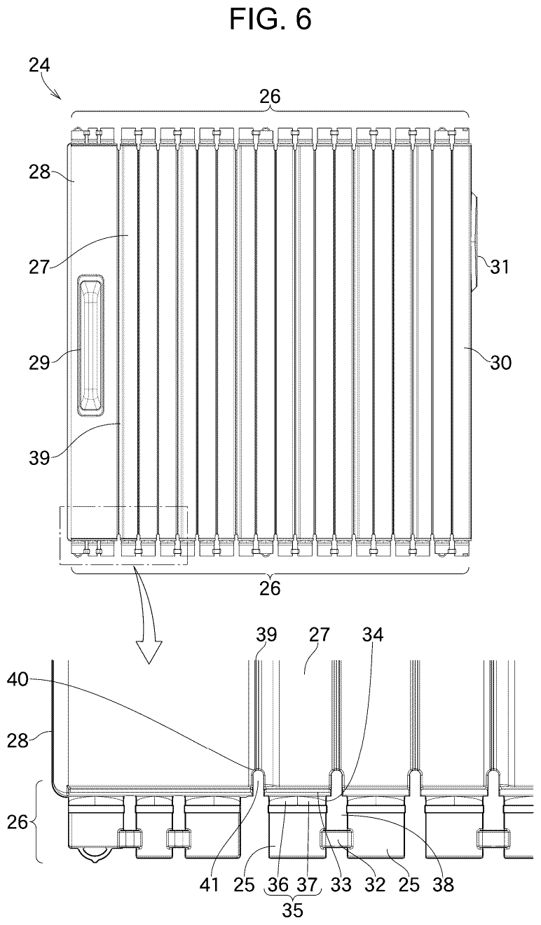

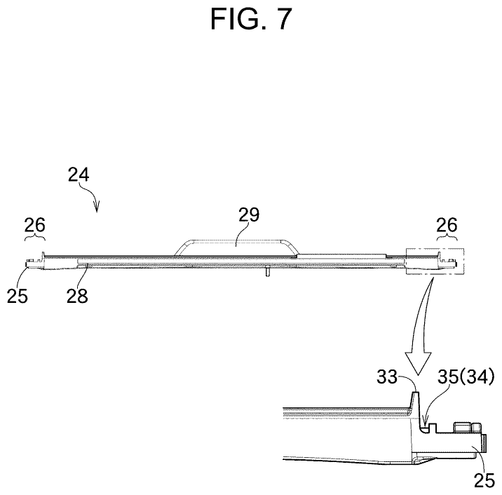

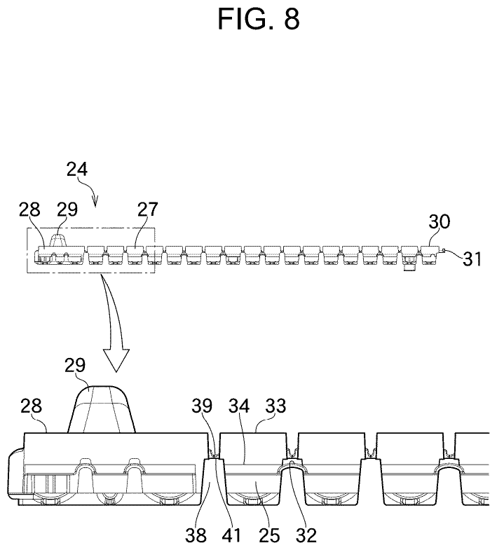

The lid 24 will be now described based on the drawings. FIGS. 5 to 8 each illustrate the external appearance of the lid 24 and an enlarged end portion 26.

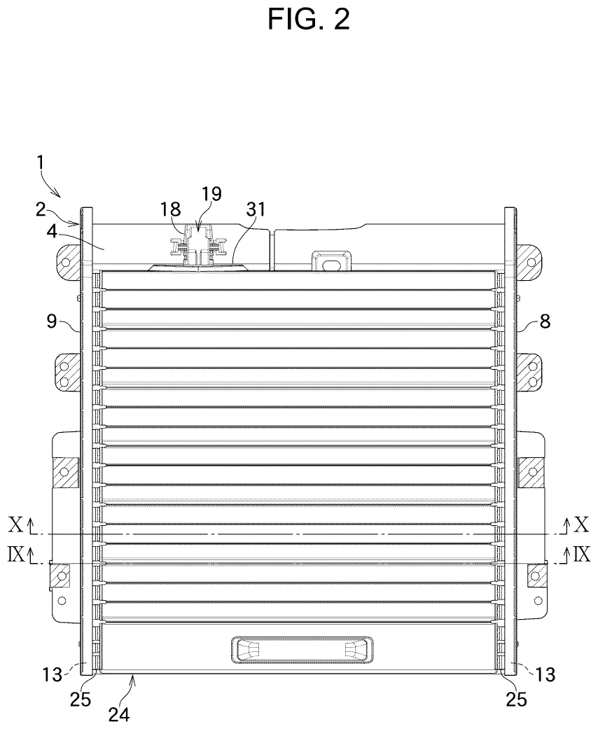

As illustrated in FIGS. 5 to 8, the lid 24 includes a plurality of lid pieces 27 that extends and ranges between the left and right end portions 26 and hinge portions 39 that extend across and between the end portions 26 and are each located between lid pieces 27. The lid pieces 27 are connected through the hinge portions 39. The hinge portions 39 are thinner than the lid pieces 27. Since the lid 24 includes the hinge portions 39, the lid 24 bends flexibly by bending through the hinge portions 39. The lid 24 includes a front lid piece 28 as its front, and the front lid piece 28 includes a knob portion 29. The knob portion 29 protrudes upward from the center of the front lid piece 28 and extends left and right. The lid 24 includes a rear lid piece 30 as its rear, and the rear lid piece 30 includes a cover portion 31. The cover portion 31 projects backward from part of the rear lid piece 30. The position of the cover portion 31 is aligned with the regulatory member housing portion 18 (regulatory member 19) of the main body 2. With the lid 24 in a close posture, the cover portion 31 covers the regulatory member housing portion 18 from above (refer to FIG. 2).

Each end portion 26 of the lid 24 includes respective ends of the lid pieces 27, hinge end portions 40 as respective ends of the hinge portions 39, and the corresponding lid rail portions 25. The lid rail portions 25 are each a plate-like member formed at an end of the corresponding lid piece 27. Respective lid rail portions 25 of two lid pieces 27 adjacent to each other are connected through an arched connecting portion 32. A plate-like rib 33 is formed at the boundary between each lid piece 27 and the corresponding lid rail portion 25. The rib 33 protrudes upward and is longer in the front-back direction than in the left-right direction. A groove portion 34 is formed on the top face of the boundary between the rib 33 and the corresponding lid rail portion 25. The groove portion 34 extends in the front-back direction, and a slope portion 35 is formed inside the groove portion 34. The slope portion 35 slopes down to a gap 38 formed between the lid rail portions 25 adjacent to one another. Therefore, the slope portion 35 includes a front slope 36 sloping to the forward adjacent lid rail portion 25 and a rear slope 37 sloping to the backward adjacent lid rail portion 25. The hinge end portions 40 each have a grooved through hole 41. The through hole 41 is formed on the side of the corresponding lid piece 27 with respect to the corresponding rib 33 (closer to the center of the lid piece 27 than the rib 33 is) in the end portion 26.

The lid structure 1 for the vehicle mounted container is formed as above. Next, operation and effect of the lid structure 1 for the vehicle mounted container will be described based on the drawings. FIGS. 9 and 10 each illustrate an enlarged cross section of an end portion 26 of the lid 24.

As illustrated in FIGS. 9 and 10, each lid rail portion 25 of the lid 24 is fitted to the corresponding sidewall rail portion 13 of the main body 2. In each end portion 26, toward a fitting area 42 between the lid rail portions 25 and the sidewall rail portion 13, each through hole 41 is disposed at a position not reaching the fitting area 42 (on the left side with respect to the fitting area 42 in FIG. 9) and is in communication with the storage space 3 below. Even in a case where foreign matter (not illustrated) on the lid 24 or foreign matter in any of the hinge portions 39 moves toward either end portion 26, such foreign matter falls to the top portion 4 through the corresponding through hole 41 without reaching the fitting area 42. In particular, since the opening edge 17 of the top portion 4 slopes down toward the storage space 3, the foreign matter slides on the opening edge 17 to fall in the storage space 3. Even in either of such cases as above, no foreign matter enters the fitting area 42. Therefore, the lid structure 1 for the vehicle mounted container is capable of preventing entry of the foreign matter and maintaining high operability. Even if foreign matter falls on the top portion 4, the top portion 4 is exposed by opening the lid 24. Thus, the foreign matter can be easily removed.

In each end portion 26, in a direction toward the fitting area 42, the ribs 33 are disposed at positions not reaching the fitting area 42 and are disposed at a position beyond the through holes 41. Even in a case where foreign matter on the lid 24 moves toward either end portion 26, the foreign matter is blocked after butting against the corresponding rib 33 without reaching the fitting area 42, so that the foreign matter fails to enter the fitting area 42. Furthermore, the foreign matter, which is blocked after butting against the corresponding rib 33, falls to the top portion 4 through the corresponding through hole 41, so that the foreign matter fails to enter the fitting area 42. Therefore, the lid structure 1 for the vehicle mounted container is capable of preventing entry of the foreign matter and maintaining high operability.

Each lid rail portion 25 has a top face on which the groove portion 34 is disposed at a position not reaching the fitting area 42. Even if foreign matter enters, through any of the through holes 41, a lid rail portion 25 or even if the foreign matter crosses over any of the ribs 33, such foreign matter enters the corresponding groove portion 34 without reaching the fitting area 42, so that the foreign matter fails to enter the fitting area 42. The groove portion 34 has the slope portion 35 sloping down to the gaps 38 each being formed between the lid rail portion 25 and one of the adjacent lid rail portions 25, namely, in a direction toward the storage space 3 below. Thus, the foreign matter slides along the slope portion 35 without reaching the fitting area 42 and falls to the top portion 4 through either of the gaps 38, so that the foreign matter fails to enter the fitting area 42. Therefore, the lid structure 1 for the vehicle mounted container is capable of preventing entry of foreign matter and maintaining high operability.

In general, the lid structure 1 for the vehicle mounted container installed in a vehicle has its end portions 26 covered with an interior panel for design, and thus the through holes 41 and the ribs 33 are also shielded by the interior panel. Therefore, the external appearance is not spoiled by the through holes 41 and the ribs 33.

Since the lid 24 is almost quadrilateral and is larger in size than a general rectangular lid, the lid 24 is vulnerable to pressure from above. However, the lid 24 has its bottom face reinforced by the metallic brackets 43 and thus is robust. On the other hand, the lid 24 is large and is weighted with the brackets 43, leading to an increase in inertial force. If the vehicle gains a large acceleration, the lid 24 tries to open due to inertial force. However, the regulatory member 19 changes to the regulatory posture and then the front end portion protrudes from the main body 2 to butt against the rear end portion of the lid 24, so that the lid 24 is restricted from opening. Therefore, the lid 24 does not open unintentionally.

The lid 24 has its rear provided with the cover portion 31, and the position of the cover portion 31 is aligned with the regulatory member housing portion 18 (regulatory member 19) of the main body 2. Thus, with the lid 24 in a close posture, the cover portion 31 covers the regulatory member housing portion 18 from above. Therefore, no foreign matter enters the regulatory member 19.

The lid 24 has an accordion structure in which the lid pieces 27 extending across and between the left and right end portions 26 are connected through the hinge portions 39, and thus the lid 24 bends freely when sliding. Therefore, the lid structure 1 for the vehicle mounted container enables the lid rail portions 25 and the sidewall rail portions 13 to be stored in a small space.

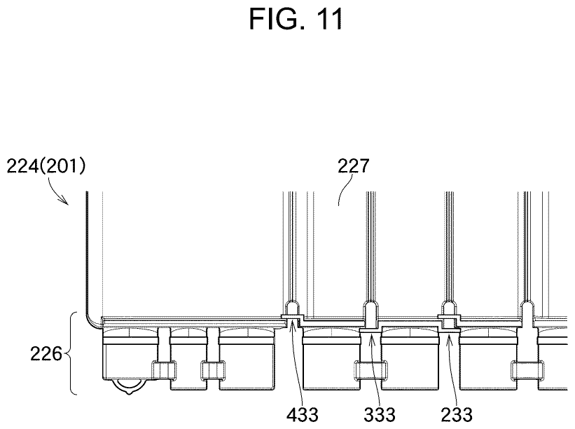

Next, a lid structure 201 for a vehicle mounted container according to a second embodiment of the present disclosure will be described based on the drawing. FIG. 11 illustrates an enlarged end portion 226 of a lid 224 in the lid structure 201 for the vehicle mounted container according to the second embodiment. Note that, mainly, differences in configuration from the lid structure 1 for the vehicle mounted container according to the first embodiment will be described below and similarities in configuration to the lid structure 1 for the vehicle mounted container will be omitted as appropriate.

As illustrated in FIG. 11, the lid 224 of the lid structure 201 for the vehicle mounted container is different in configuration from the lid 24 of the lid structure 1 for the vehicle mounted container in terms of ribs 233, 333, and 433. In the lid 224, respective ribs 233 formed on adjacent lid pieces 227 extend in directions in which the ribs 233 come close to each other, the ribs 233 overlapping each other with a gap in a left-right direction (up-down direction in FIG. 11). In other words, the ribs 233 overlap each other in a stepwise manner. Even in a case where foreign matter on the lid 224 moves toward the end portion 226, the foreign matter is blocked after butting against the overlapping ribs 233, so that the foreign matter fails to enter a fitting area. The ribs 333 and 433 each extend from a lid piece 227 to an adjacent lid piece 227. Even in this case, the foreign matter is blocked after butting against the rib 333 or the rib 433, so that the foreign matter fails to enter the fitting area. Therefore, the lid structure 201 for the vehicle mounted container is capable of preventing entry of the foreign matter and maintaining high operability.

Note that, in another embodiment of the present disclosure, the number of through holes, the position of each through hole, and the size of each through hole are freely selected. In this embodiment, for example, the through holes are each formed at any place out of the end portions of a lid piece or at any place out of the end portions of a hinge portion. Therefore, even in a case where foreign matter on a lid or foreign matter in any of the hinge portions moves toward either end portion, such foreign matter falls in a storage space through the corresponding through hole, so that the foreign matter fails to enter a fitting area.

In another embodiment, the number of ribs, the position of each rib, and the length of each rib are freely selected. In this embodiment, for example, the ribs are each formed at any place out of the end portions of a lid. Therefore, the foreign matter on the lid is blocked after butting against any of the ribs, so that the foreign matter fails to enter a fitting area.

In another embodiment, sidewall portions each have a straight edge portion, and a lid slides horizontally without bending. In this embodiment, the lid may be plate-like with no hinge portions.

In another embodiment, sidewall portions each have a protruding sidewall rail portion, and a lid has grooved lid rail portions.

In another embodiment, a main body has a rectangular top portion.

In another embodiment, no groove portions and no slope portions are provided.

In another embodiment, no regulatory member and no cover portion are provided.

In another embodiment, no ribs are provided.

In a reference example of the present disclosure, with no through holes, ribs are provided.

Some embodiments of the present disclosure have been described above, but the present disclosure is not limited to the embodiments described above. The present disclosure can be carried out in various modified designs without departing from the scope of the claims.

### Reference Signs List

1, 201 Lid structure for a vehicle mounted container
2 Main body
3 Storage space
4 Top portion
5 Rear portion
6 Left inner side portion
7 Right inner side portion
8 Left sidewall portion (sidewall portion)
9 Right sidewall portion (sidewall portion)
10 Upper straight portion
11 Curved edge portion
12 Lower straight edge portion
13 Sidewall rail portion
14 Opening portion
15 Right opening portion
16 Left opening portion
17 Opening edge
18 Regulatory member housing portion
19 Regulatory member
24, 224 Lid
25 Lid rail portion
26, 226 End portion
27, 227 Lid piece
28 Front lid piece
29 Knob portion
30 Rear lid piece
31 Cover portion
32 Connecting portion
33, 233 Rib
34 Groove portion
35 Slope portion
36 Front slope
37 Rear slope
38 Gap
39 Hinge portion
40 Hinge end portion
41 Through hole
42 Fitting area
43 Bracket

What is claimed is:

1. A lid structure for a vehicle mounted container comprising:
a main body including an opening portion communicating with an inner storage space thereof and located on a top face of the main body; and
a lid for opening or closing the opening portion, wherein
lid rail portions formed on two side portions of the lid are fit in a slidable manner to sidewall rail portions formed on respective inner faces in a pair of sidewall portions as side faces of the main body, allowing the lid to slide along the opening portion, and p1 the lid has through holes communicating with the storage space.

2. The lid structure for the vehicle mounted container according to claim 1, wherein the lid includes a plurality of hinge portions extending across and between the side portions, and is capable of bending through the hinge portions when sliding.

3. The lid structure for the vehicle mounted container according to claim 2, wherein the through holes are formed in the hinge portions.

4. The lid structure for the vehicle mounted container according to claim 1, wherein in each of the end portions, in a direction toward a fitting area between the lid rail portion and the sidewall rail portion corresponding thereto, each through hole is formed on a side before the fitting area.

5. The lid structure for the vehicle mounted container according to claim 2, wherein in each of the end portions, in a direction toward a fitting area between the lid rail portion and the sidewall rail portion corresponding thereto, each through hole is formed at a side before the fitting area.

6. The lid structure for the vehicle mounted container according to claim 3, wherein in each of the end portions, in a direction toward a fitting area between the lid rail portion and the sidewall rail portion corresponding thereof, each through hole is formed at a side before the fitting area.

7. The lid structure for the vehicle mounted container according to claim 1, wherein
the lid rail portions protrude to the sidewall rail portions corresponding thereto, and
each of the lid rail portions includes a slope portion on a top face of the lid rail portion on a side before a fitting area between the lid rail portion and the sidewall rail portion corresponding thereto, the slope portion sloping to a gap formed between the lid rail portions adjacent to one another.

8. The lid structure for the vehicle mounted container according to claim 2, wherein
the lid rail portions protrude to the sidewall rail portions corresponding thereto, and
each of the lid rail portions includes a slope portion on a top face of the lid rail portion on a side before a fitting area between the lid rail portion and the sidewall rail portion corresponding thereto, the slope portion sloping to a gap formed between the lid rail portions adjacent to one another.

9. The lid structure for the vehicle mounted container according to claim 3, wherein
the lid rail portions protrude to the sidewall rail portions corresponding thereto, and
each of the lid rail portions includes a slope portion on a top face of the lid rail portion on a side before a fitting area between the lid rail portion and the sidewall rail portion corresponding thereto, the slope portion sloping to a gap formed between the lid rail portions adjacent to one another.

10. The lid structure for the vehicle mounted container according to claim 1, wherein the main body includes a regulatory member that restricts the lid from opening due to acceleration.

11. The lid structure for the vehicle mounted container according to claim 2, wherein the main body includes a regulatory member that restricts the lid from opening due to acceleration.

12. The lid structure for the vehicle mounted container according to claim 3, wherein the main body includes a regulatory member that restricts the lid from opening due to acceleration.

13. The lid structure for the vehicle mounted container according to claim 10, wherein the lid includes a cover portion that covers the regulatory member.

14. The lid structure for the vehicle mounted container according to claim 11, wherein the lid includes a cover portion that covers the regulatory member.

15. The lid structure for the vehicle mounted container according to claim 12, wherein the lid includes a cover portion that covers the regulatory member.

16. The lid structure for the vehicle mounted container according to claim 1, wherein the lid includes elongated ribs that protrude upward in a direction in which the lid rail portions extend.

17. The lid structure for the vehicle mounted container according to claim 2, wherein the lid includes elongated ribs that protrude upward in a direction in which the lid rail portions extend.

18. The lid structure for the vehicle mounted container according to claim 16, wherein in each of the end portions, in a direction toward a fitting area between the lid rail portion and the sidewall rail portion corresponding thereto, the rib is formed at a side before the fitting area.

19. The lid structure for the vehicle mounted container according to claim 16, wherein in each of the end portions, in a direction toward a fitting area between the lid rail portion and the sidewall rail portion corresponding thereto, the rib is located at a side beyond the through hole.

20. The lid structure for the vehicle mounted container according to claim 17, wherein
the lid includes a plurality of lid pieces connected through the hinge portions, and
a plurality of the ribs formed on respective adjacent lid pieces extends in directions in which the ribs come close to each other, the ribs overlapping each other with a gap.
